(19) United States
(12) Patent Application Publication
(10) Pub. No.: US 2009/0119206 A1
(43) Pub. Date: May 7, 2009

(54) METHODS FOR ROUTING A COMMERCIAL TO A DESTINATION DEVICE ON A LOCAL AREA NETWORK (LAN) AND RELATED ELECTRONIC DEVICES AND COMPUTER PROGRAM PRODUCTS

(75) Inventor: Sten Hakan Minor, Lund (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/934,519

(22) Filed: Nov. 2, 2007

(51) Int. Cl. G06Q 40/00; G06F 15/16; G06F 9/46

(52) U.S. Cl. 705/40; 709/218; 718/100

(57) ABSTRACT

An electronic device is operated by receiving a commercial from a service provider. The commercial is processed to identify a destination device on a Local Area Network (LAN) to which the commercial is to be sent. The commercial is then sent to the destination device.

### BACKGROUND OF THE INVENTION

The present invention relates to communication networks, and, more particularly, to methods, electronic devices, and computer program products for delivering a commercial to a user.

Services and/or products are often sold through the use of commercials or advertisements. The commercials may be very different depending on the medium in which they are shown, the type of product and/or service being advertised, and/or the target customer. For example, television commercials typically interrupt a television show or movie. On the Internet, commercials may be presented to the user in the form of a pop-up window and/or in a window pane or portion of a window that may include a link for more information. On the radio, commercials are typically delivered in a similar manner as television with the audio of the commercial interrupting the regular programming. Commercials may also be delivered to a user via electronic mail or via text-message. Such commercials are sometimes referred to as “spam.”

### SUMMARY OF THE INVENTION

According to some embodiments of the present invention, an electronic device is operated by receiving a commercial from a service provider. The commercial is processed to identify a destination device on a Local Area Network (LAN) to which the commercial is to be sent. The commercial is then sent to the destination device.

In other embodiments, processing the commercial includes processing the commercial to determine a time that the commercial is to be played and sending the commercial to the destination device based on the time that the commercial is to be played.

In still other embodiments, sending the commercial to the destination device includes determining whether the destination device is powered on and sending the commercial to the destination device when the destination device is powered on.

In still other embodiments, receiving the commercial from the service provider includes receiving a link from the service provider that identifies an address for a repository that contains the commercial and obtaining the commercial from the repository.

In still other embodiments, receiving the link includes receiving a Short Message Service (SMS) message that includes the link from the service provider.

In still other embodiments, operating the electronic device further includes receiving a notification from the destination device at the electronic device that the commercial has played and notifying the service provider that the commercial has played.

In still other embodiments, the LAN supports communication between the electronic device and the destination device via IEEE 802.11bg Wireless Local Area Network (WLAN) and/or Bluetooth technology.

In still other embodiments, the LAN comprises a Digital Living Network Alliance (DLNA) network.

In still other embodiments, the electronic device is a mobile terminal.

In still other embodiments, the electronic device comprises a gateway device and/or modem device.

In other embodiments of the present invention, an electronic device is operated by sending a commercial to a routing device on a LAN, the commercial including routing information that associates the commercial with destination device types that are configured to play the commercial, and receiving notification from the routing device that the commercial has been played by a destination device on the LAN.

In still other embodiments, sending the commercial to the routing device includes sending a link to the routing device that identifies an address for a repository that contains the commercial.

In still other embodiments, sending the link includes sending a SMS message that includes the link.

In still other embodiments, operating the electronic device further includes sending an invoice to an advertiser associated with the commercial responsive to receiving notification that the commercial has been played.

In still other embodiments, the electronic device is associated with a service provider.

In still other embodiments, the routing device comprises a mobile terminal, gateway device, and/or modem device.

In still other embodiments, the LAN supports communication via IEEE 802.11b/g WLAN and/or Bluetooth technology.

In still other embodiments, the LAN comprises a DLNA network.

In still other embodiments, the commercial further includes time information that specifies when the commercial can be played.

In further embodiments of the present invention, an electronic device is provided that is configured to carry out various ones of the above-described operations.

In still further embodiments of the present invention, a computer program product includes computer-readable program code embodied on a computer-readable medium, the computer readable program code being configured to carry out various ones of the above-described operations.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a is a block diagram that illustrates a communication network in accordance with some embodiments of the present invention;

FIG. 2 is a block diagram that illustrates an electronic device/mobile terminal in accordance with some embodiments of the present invention; and

FIG. 3 is a message flow diagram that illustrates operations for delivering a commercial to a destination device in a Local Area Network (LAN) in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store or transport the program for use by or in connection with the instriction execution system, apparatus, or device.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium would include the following: a portable computer diskette, a random access memory (RAM), a read-only memory (ROM), an erasable programmable read-only memory (EPROM or Flash memory), and a compact disc read-only memory (CD-ROM).

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

For purposes of illustration, some embodiments of the present invention are described herein in the context of a mobile terminal being used as a commercial routing hub in a Local Area Network (LAN). It will be understood, however, that the present invention is not limited to such embodiments and may be embodied using other devices, such as a gateway device or modem, for example, as the commercial routing hub for the LAN.

As used herein, the term “commercial” encompasses the term advertisement and is not limited to a particular product or service and is also not limited to a particular media type. Accordingly, a commercial may be presented to a user via audio, video, text, graphic, and/or other media type, in accordance with various embodiments of the present invention.

Some embodiments of the present invention stem from a realization that a user may have multiple electronic devices that he/she uses that can be used for presentation of a commercial. A device, such as a mobile terminal, may be configured as a routing hub for receiving commercials. The commercials may be tagged with indicators that specify the device(s) that may be the most appropriate for presenting the commercials to the user. The mobile terminal may then route the commercials to the appropriate device over a LAN. Once the commercial is received at the destination device, it can be presented to the user.

Embodiments according to the invention can operate in a logically separated client side/server side-computing environment, sometimes referred to hereinafter as a client/server environment. A client may communicate with a server over a wireless and/or wireline communication medium. The client/server environment is a computational architecture that involves a client process (i.e., a client) requesting service from a server process (i.e., a server). In general, the client/server environment maintains a distinction between processes, although client and server processes may operate on different machines or on the same machine. Accordingly, the client and server sides of the client/server environment are referred to as being logically separated. Usually, when client and server processes operate on separate devices, each device can be customized for the needs of the respective process. For example, a server process can “run on” a system having large amounts of memory and disk space, whereas the client process often “runs on” a system having a graphic user interface provided by high-end video cards and large-screen displays.

A client can be a program, such as a Web browser, that requests information, such as web pages, from a server under the control of a user. Examples of clients include browsers such as Netscape Navigator® (America Online, Inc., Dulles, Va.) and Internet Explorer® (Microsoft Corporation, Redmond, Wash.). Browsers typically provide a graphical user interface for retrieving and viewing web pages, web portals, applications, and other resources served by Web servers. A SOAP client can be used to request web services programmatically by a program in lieu of a web browser. The applications provided by the service providers may execute on a server. The server can be a program that responds to the requests from the client. Some examples of servers are International Business Machines Corporation's family of Lotus Domino® servers, the Apache server and Microsoft's Internet Information Server (IIS) (Microsoft Corporation, Redmond, Wash.).

The clients and servers can communicate using a standard communications mode, such as Hypertext Transport Protocol (HTTP) and SOAP. According to the HTTP request-response communications model, HTTP requests are sent from the client to the server and HTTP responses are sent from the server to the client in response to an HTTP request. In operation, the server waits for a client to open a connection and to request information, such as a Web page. In response, the server sends a copy of the requested information to the client, closes the connection to the client, and waits for the next connection. It will be understood that the server can respond to requests from more than one client.

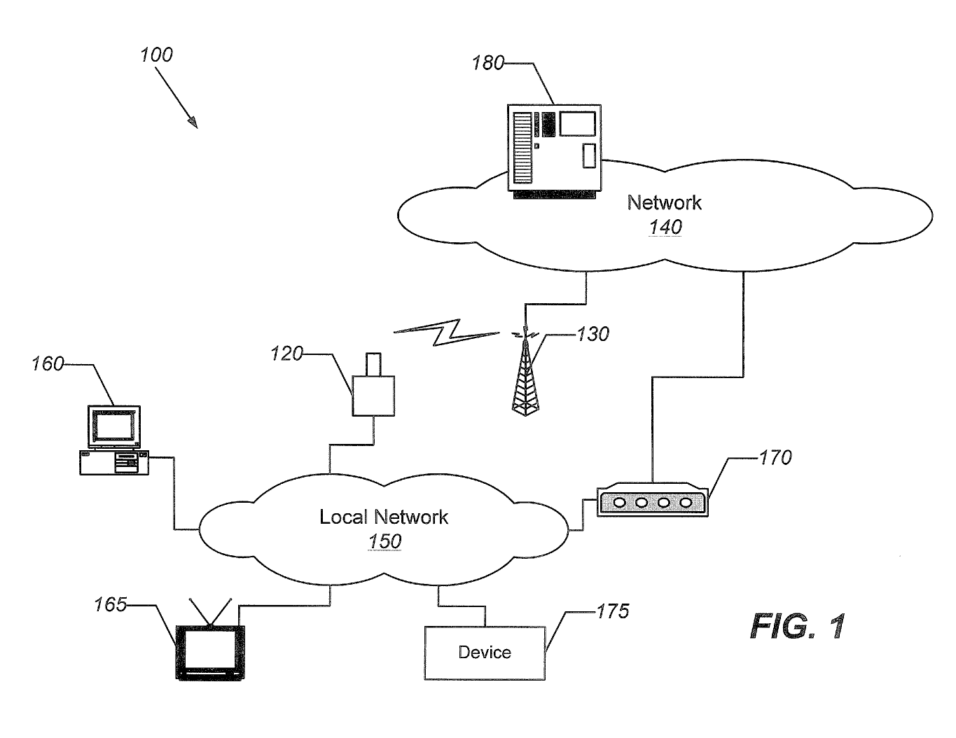

Referring to FIG. 1, a communication network architecture 100, according to some embodiments of the present invention, includes a mobile terminal 120 and an Internet server 180 that are connected via a network 140 as shown. The network 140 includes wireless base station transceiver(s) 130 that may facilitate wireless communication with the mobile terminal 120. The network 140 may represent a global network, such as the Internet, or other publicly accessible network. The network 140 may also, however, represent a wide area network, a local area network, an Intranet, or other private network, which may not accessible by the general public. Furthermore, the network 140 may represent a combination of public and private networks or a virtual private network (VPN). Moreover, device 120 is described as a mobile terminal for purposes of illustrating some embodiments of the present invention. The Internet server 180 may be associated with a service provider and may be configured to send commercials to users that subscribe to the service. For example, the Internet server 180 may be associated with a telecommunications service provider, a cable or satellite service provider, an Internet service provider, a news service provider (i.e., a newspaper or magazine), a radio service provider, and/or the like. When a user subscribes to the service offered by the service provider associated with the Internet server 180, the user may be required to agree to receive commercials from the service provider. These commercials may be for other services and/or products offered by the service provider or for services and/or products offered by other organizations that choose to advertise through the service provider.

The mobile terminal 120 may be configured to operate as part of a LAN 150 that allows multiple devices to communicate with one another. These devices may include, but are not limited to, a computer 160, a television 165, a gateway device and/or modem 170, and/or other device(s) 175. Examples of the other devices may include, but are not limited to, a radio/stereo, an appliance, such as a refrigerator, a vacuum cleaner, an HVAC unit, a range, an oven, a dishwasher, etc., a clock, a car, etc. The devices on the LAN 150 may include any device that has the processing and communication capability to communicate using the LAN 150 protocol. The LAN 150 may be configured to facilitate communication using wireless protocols, such as, for example, WiFi, Wireless LAN (WLAN), and/or Bluetooth. The Bluetooth protocol is an open standard for short-range and low speed wireless transmission of digital voice and data in the unlicensed 2.4 GHz band, which supports both point-to-point and multipoint applications. The WLAN protocol may facilitate wireless communication between devices using, for example, the IEEE 802.11b/g standard. The LAN 150 may also facilitate communication using wired protocols, such as Ethernet. In some embodiments, the LAN 150 may be configured as a Digital Living Network Alliance (DLNA) network. It will be understood that the LAN 150 may facilitate communication between devices thereon using one or more wired and/or wireless communication protocols in accordance with various embodiments of the present invention.

According to some embodiments of the present invention, the mobile terminal 120 may be configured to receive commercials and/or links to commercials from the Internet server 180. These commercials may then be routed to a destination device on the LAN 150 that is appropriate for presentation to the user. While exemplary embodiments of the present invention are described herein in the context of the mobile terminal 120 acting as a routing hub for the commercials on the LAN 150, it will be understood that other devices, such as the gateway device and/or modem 170 may also be used as the routing hub for commercials on the LAN 150.

Although FIG. 1 illustrates an exemplary communication network, it will be understood that the present invention is not limited to such configurations, but is intended to encompass any configuration capable of carrying out the operations described herein.

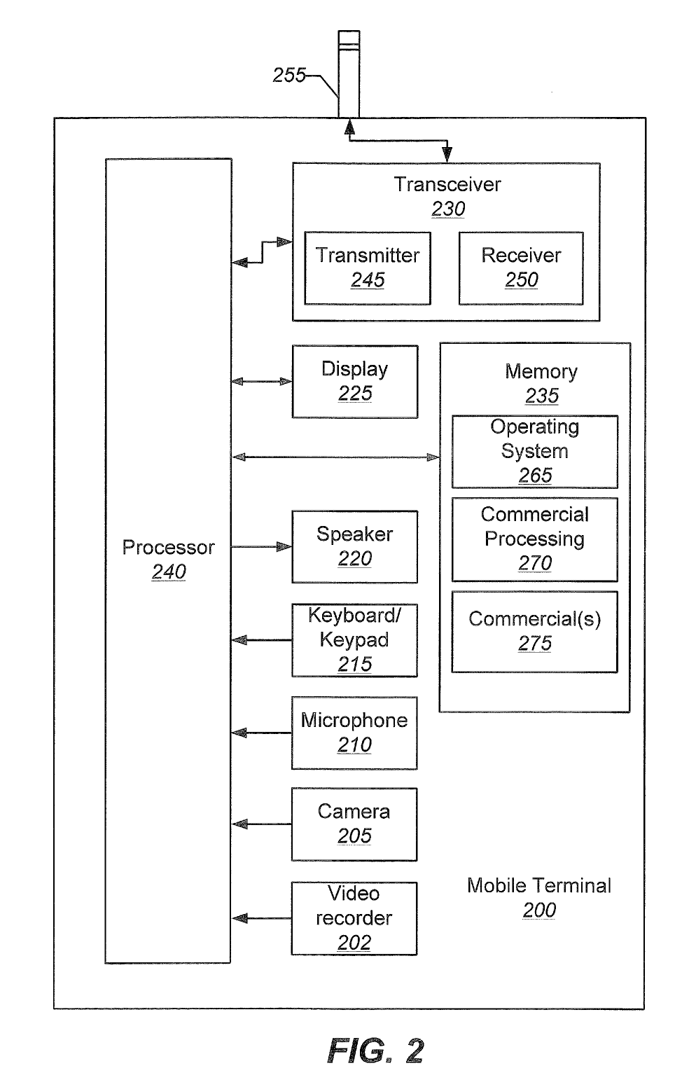

Referring to FIG. 2, an exemplary mobile terminal 200 that may be used to implement mobile terminal 120 of FIG. 1, in accordance with some embodiments of the present invention, includes a video recorder 202, a camera 205, a microphone 210, a keyboard/keypad 215, a speaker 220, a display 225, a transceiver 230, and a memory 235 that communicate with a processor 340. The transceiver 230 comprises a transmitter circuit 245 and a receiver circuit 250, which respectively transmit outgoing radio frequency signals to base station transceivers and receive incoming radio frequency signals from the base station transceivers via an antenna 255. The radio frequency signals transmitted between the mobile terminal 200 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 200 may be included in many conventional mobile terminals and their functionality is generally known to those skilled in the art.

The transmitter circuit 245 and receiver circuit 250 may also represent Bluetooth and/or WLAN transceiver circuits to facilitate communication on a LAN, for example. In accordance with various embodiments of the present invention, both the Bluetooth transceiver and the WLAN transceiver may share the same antenna or each transceiver may have a dedicated antenna associated therewith. In addition, the Bluetooth transceiver circuit may facilitate wireless communication with other Bluetooth enabled devices using the Bluetooth protocol. As discussed above, the Bluetooth protocol is an open standard for short-range and low speed wireless transmission of digital voice and data in the unlicensed 2.4 GHz band, which supports both point-to-point and multipoint applications. The WLAN transceiver circuit may facilitate wireless communication with devices on a local area network using, for example, the IEEE 802.11 standard.

The processor 240 communicates with the memory 235 via an address/data bus. The processor 240 may be, for example, a commercially available or custom microprocessor. The memory 235 is representative of the one or more memory devices containing the software and data used to process and route commercials to a destination device in a LAN, in accordance with some embodiments of the present invention. The memory 335 may include, but is not limited to, the following types of devices: cache, ROM, PROM, EPROM, EEPROM, flash, SRAM, and DRAM.

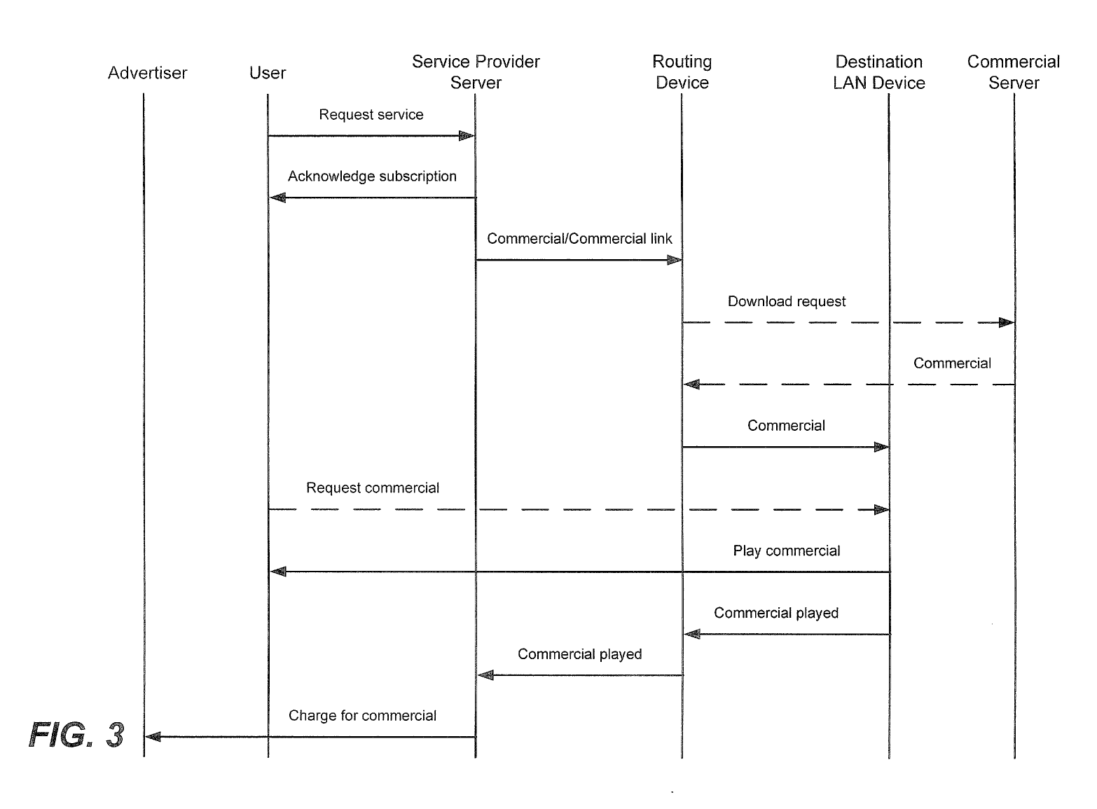

As shown in FIG. 2, the memory 235 may contain up to three or more categories of software and/or data: an operating system 265, a commercial processing module 270, and the commercial(s) and/or links thereto 275. The operating system 265 generally controls the operation of the mobile terminal 200. In particular, the operating system 265 may manage the mobile terminal's software and/or hardware resources and may coordinate execution of programs by the processor 240. The commercial processing module may be configured to receive commercial(s) 275 and/or links thereto from the Internet server 180 of FIG. 1, which may be associated with a service provider. The commercial processing module 270 may examine the commercial to determine an appropriate destination device for presenting the commercial to the user. The commercial processing module 270 may then send the commercial to the destination device that has been determined to be appropriate for presenting the commercial. Exemplary operations of the commercial processing module 270 are described in detail below with reference to FIG. 3.

Although FIG. 2 illustrates an exemplary software and hardware architecture that may be used to receive commercials at a mobile terminal and route the commercials to an appropriate destination device on a LAN for presenting the commercials to a user, it will be understood that the present invention is not limited to such a configuration, but is intended to encompass any configuration capable of carrying out the operations described herein.

Computer program code for carrying out operations of devices and/or systems discussed above with respect to FIGS. 1-2 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to message flow diagram illustrations of methods, electronic devices, mobile terminals, Internet servers, and/or computer program products in accordance with some embodiments of the invention.

These message flow diagrams further illustrate exemplary operations of routing commercials to various devices on a LAN for presentation to a user in accordance with some embodiments of the present invention. It will be understood that each message, and combinations of messages in the message flow diagram illustrations, may be generated/implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the message flow diagram(s).

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the message flow diagram(s).

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the message flow diagram(s).

FIG. 3 is a message flow diagram that illustrates operations for routing commercials to a destination device for presentation to a user in a LAN in accordance with some embodiments of the present invention. Referring to FIG. 3, and FIGS. 1 and 2, a user subscribes to a service or otherwise registers his/her contact information with a service provider. This subscription/registration can be done through any means or device. The service provider may acknowledge the subscription/registration and inform the user that by subscribing/registering he/she agrees to receive commercials from the service provider or other advertisers.

The service provider may send one or more commercials and/or links thereto from the Internet server 180 to a routing device on the LAN 150. In some embodiments, the routing device may be the mobile terminal 120. The mobile terminal 120 may be selected as the routing device because it may be easily addressed by a phone number and it is routinely carried by the user. Accordingly, the mobile terminal 120 may connect to an accessible LAN where it is currently located. In this manner, the LAN 150 may include devices that are “discovered” by the routing device, such as the mobile terminal 120. In other embodiments, a device, such as the gateway and/or modem device 170 may be used as the routing device on the LAN 150.

As described above, the service provider may send the full commercial to the routing device and/or may send a link for the commercial to the routing device. The link may be communicated via a Short Message Service (SMS) message to the routing device. To retrieve the commercial, the routing device may forward a download request, for example, to a commercial server identified by the link to retrieve the commercial.

According to some embodiments of the present invention, the commercial may be tagged so as to identify an appropriate destination device on the LAN 150 for presenting the commercial to the user. Audio commercials can be played, for example, on a mobile phone, a radio/stereo, or even as a wake up signal on an alarm clock. Audio, video, graphic, text, and/or link commercials can be routed to desktop or laptop computer or a PDA, for example. Food commercials may be routed to devices or appliances typically located in the kitchen, such as the refrigerator, range, microwave, etc. Car commercials may be routed to the dashboard of the car. Vacuum cleaner bag commercials may be routed to the vacuum cleaner, etc. In other embodiments, the commercial may be tagged to indicate a time at which the commercial may be presented. In this case, the routing device may delay sending the commercial to the destination device until the time specified in the commercial for presenting the commercial to the user is reached. In other embodiments, the routing device may send the commercial to the destination device immediately and the destination device may delay presenting the commercial to the user until the time specified in the commercial tag is reached.

In some embodiments, the routing device may be configured to determine whether a destination is powered on or off and may delay sending the commercial to the destination device on the LAN until the destination device is determined to be in a powered on state.

Returning to FIG. 3, once the commercial processing module 270 sends the commercial to the appropriate destination device on the LAN 150, which may include the routing device itself, the commercial may play automatically or may play in response to a user request for the commercial. For example, the commercial may be presented to the user as an icon on a television screen, mobile terminal display, computer monitor, or other embedded system display. The user may then click on the icon to read, view, and/or listen to the commercial.

In some embodiments, the destination device on the LAN 150 may inform the routing device that the commercial has played. The commercial processing module 270 may then forward this information to the service provider. If the commercial is associated with a third party advertiser, i.e., an advertiser other than the service provider, then the service provider may accumulate statistics on how many times the advertiser's commercial has been displayed and invoice the advertiser accordingly. In this way, the service provider may effectively sell advertising space on a user's devices on a LAN. Thus, embodiments of the present invention may provide a relatively easy way to set up an advertising network, which service providers may take advantage of to supplement their revenue stream without increasing fees to their customers.

The message flow diagrams of FIG. 3 illustrates the architecture, functionality, and operations of embodiments of methods, electronic devices, mobile terminals, Internet servers, and/or computer program products for routing commercials to destination devices in a LAN. In this regard, each message and associated communication represents a module, segment, or portion of code, which comprises one or more executable instructions for implementing the specified logical function(s). It should also be noted that in other implementations, the message(s) noted in the blocks may occur out of the order noted in FIG. 3. For example, two messages shown in succession may, in fact, be communicated substantially concurrently or the messages may sometimes be communicated in the reverse order, depending on the functionality involved.

Many variations and modifications can be made to the embodiments without substantially departing from the principles of the present invention. All such variations and modifications are intended to be included herein within the scope of the present invention, as set forth in the following claims.

That which is claimed:

1. A method of operating an electronic device, comprising:
receiving a commercial from a service provider at the electronic device;
processing the commercial to identify a destination device on a Local Area Network (LAN) to which the commercial is to be sent; and
sending the commercial to the destination device.

2. The method of claim 1, wherein processing the commercial comprises:
processing the commercial to determine a time that the commercial is to be played; and
sending the commercial to the destination device based on the time that the commercial is to be played.

3. The method of claim 1, wherein sending the commercial to the destination device comprises:
determining whether the destination device is powered on; and
sending the commercial to the destination device when the destination device is powered on.

4. The method of claim 1, wherein receiving the commercial from the service provider comprises:
receiving a link from the service provider that identifies an address for a repository that contains the commercial; and
obtaining the commercial from the repository.

5. The method of claim 4, wherein receiving the link comprises receiving a Short Message Service (SMS) message that includes the link from the service provider.

6. The method of claim 1, further comprising:
receiving a notification from the destination device at the electronic device that the commercial has played; and
notifying the service provider that the commercial has played.

7. The method of claim 1, wherein the LAN supports communication between the electronic device and the destination device via IEEE 802.11b/g Wireless Local Area Network (WLAN) and/or Bluetooth technology.

8. The method of claim 1, wherein the LAN comprises a Digital Living Network Alliance (DLNA) network.

9. The method of claim 1, wherein the electronic device is a mobile terminal.

10. The method of claim 1, wherein the electronic device comprises a gateway device and/or modem device.

11. An electronic device configured to carry out the method of claim 1.

12. A computer program product comprising computer-readable program code embodied on a computer-readable medium, the computer readable program code being configured to carry out the method of claim 1.

13. A method of operating an electronic device, comprising:
sending a commercial to a routing device on a Local Area Network (LAN), the commercial comprising routing information that associates the commercial with destination device types that are configured to play the commercial; and
receiving notification from the routing device that the commercial has been played by a destination device on the LAN.

14. The method of claim 13, wherein sending the commercial to the routing device comprises:
sending a link to the routing device that identifies an address for a repository that contains the commercial.

15. The method of claim 13, wherein sending the link comprises sending a Short Message Service (SMS) message that includes the link.

16. The method of claim 13, further comprising:
sending an invoice to an advertiser associated with the commercial responsive to receiving notification that the commercial has been played.

17. The method of claim 13, wherein the electronic device is associated with a service provider.

18. The method of claim 13, wherein the routing device comprises a mobile terminal, gateway device, and/or modem device.

19. The method of claim 13, wherein the LAN supports communication via IEEE 802.11b/g Wireless Local Area Network (WLAN) and/or Bluetooth technology.

20. The method of claim 13, wherein the LAN comprises a Digital Living Network Alliance (DLNA) network.

21. The method of claim 13, wherein the commercial further comprises time information that specifies when the commercial can be played.

22. An electronic device configured to carry out the method of claim 13.
